(19) United States
(12) Patent Application Publication
(10) Pub. No.: US 2014/0330610 A1
(43) Pub. Date: Nov. 6, 2014

(54) SYSTEMS AND METHODS FOR VISUAL SCHEDULE BUILDING

(71) Applicants: Alan Weeks, Vaudreuil-Dorion (CA); Sean Weeks, Vaudreuil-Dorion (CA)

(72) Inventors: Alan Weeks, Vaudreuil-Dorion (CA); Sean Weeks, Vaudreuil-Dorion (CA)

(21) Appl. No.: 13/887,332

(22) Filed: May 5, 2013

(51) Int. Cl. G06Q 10/06

(52) U.S. Cl. CPC G06Q 10/06314
USPC 705/7.24

(57) ABSTRACT

Methods, systems and computer readable media for visual schedule building are disclosed.

### TECHNICAL FIELD

Embodiments relate generally to computerized scheduling systems, and more particularly, to methods, systems and computer readable media for visual schedule building.

### BACKGROUND

Some existing computerized scheduling systems may not provide a convenient way to visualize a schedule. Moreover, some existing scheduling systems may not provide a graphical user interface for visually building a schedule including desired resource days/times and days/times when no resources should be scheduled.

Embodiments were conceived in light of the above mentioned needs, problems and/or limitations, among other things.

### SUMMARY

One or more embodiments can include a method for visual schedule building. The method can include connecting, using one or more processors, to a resource database. The method can also include receiving, at the one or more processors, static resource data from the resource database and receiving, at the one or more processors, dynamic resource data from the resource database.

The method can further include obtaining, at the one or more processors, user resource selections. Obtaining user resource selections can includes obtaining one or more active institution/organization time durations (e.g., school terms), presenting, for display to the user, courses associated with the one or more active terms, and obtaining an add indication from the user for one or more courses.

The method can also include generating, using the one or more processors, a set of results based on the user resource selections, the set of results including one or more weekly schedules. The method can further include providing user interface controls adapted to permit the user to visually move through the set of results by displaying a weekly view of one weekly schedule from the set of results.

The method can also include providing a user interface element adapted to permit the user to graphically select time blocks to avoid scheduling courses in and resorting the results set based on selected time blocks to avoid. The method can further include obtaining one or more limiting selections and generating a new set of results based on the limiting selections.

Obtaining the user resource selections can further include receiving one or more section preferences. Obtaining the user resource selections can further include receiving a sort preference.

The user interface can include a combined user interface with a first section adapted to permit a user to search courses, a second section adapted to add courses and a third section adapted visually review the results in an integrated interface.

Some implementations can include a system comprising one or more processors configured to perform operations. The operations can include the method steps described above. Further, the system can include other features as mentioned above regarding the method implementation.

Some implementations can include a nontransitory computer readable medium having stored thereon software instructions that, when executed by a processor, cause the processor to perform operations. The operations can include the method steps described above. Further, the system can include other features as mentioned above regarding the method implementation.

### BRIEF DESCRIPTION OF THE DRAWINGS

FIG. 1 is a diagram of an example visual schedule building environment for course schedules in accordance with at least one implementation.

FIG. 2 is a diagram of an example visual schedule building environment for resource scheduling in accordance with at least one implementation.

FIG. 3 is a flow chart showing an example method for visual schedule building in accordance with at least one implementation.

FIG. 4 is a flow chart showing an example method for visual schedule building in accordance with at least one implementation.

FIG. 5 is a diagram of an example computer system for visual schedule building in accordance with at least one implementation.

FIG. 6 is an example user interface for visual schedule building in accordance with at least one implementation.

FIG. 7 is an example integrated user interface for visual schedule building in accordance with at least one implementation.

### DETAILED DESCRIPTION

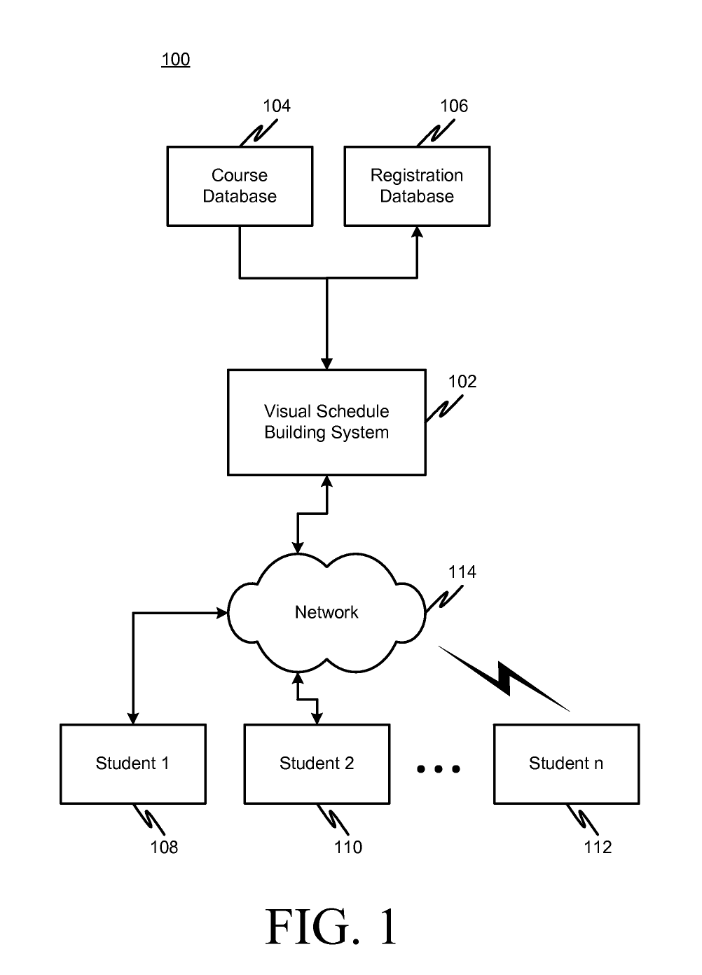

FIG. 1 is a diagram of an example visual schedule building environment 100 for course schedules in accordance with at least one implementation. The environment 100 includes a visual schedule building system 102 adapted for use in scheduling courses, such as university or college courses, or courses (or other types of presentations) for other types of institutions or organizations. The visual schedule building system 102 is coupled to a course database 104 and a registration database 106. The visual schedule building system 102 may be coupled to the databases (104 and 106) via one or more intermediate systems.

A plurality of students (108-112) can access the visual schedule building system 102 via a wired and/or wireless network 114.

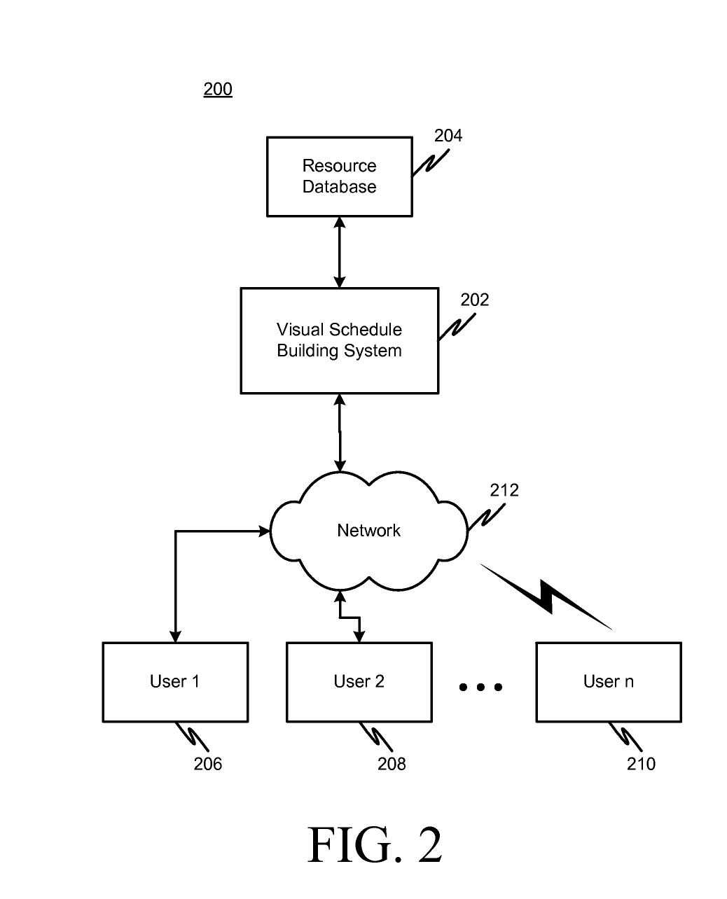

While course scheduling embodiments are described herein, it will be appreciated that the visual schedule building system disclosed herein can be adapted for use in scheduling other types of resources. For example, FIG. 2 is a diagram of an example visual schedule building environment 200 for resource scheduling. The environment 200 includes a visual schedule building system 202 adapted for use in scheduling resources, such as personnel, physical spaces, equipment or other resources where scheduling may be appropriate or desirable. The resources can be scheduled for one or more time durations (e.g., a time period with a start date and time and an end date and time). The visual schedule building system 202 is coupled to a resource database 204. The visual schedule building system 202 may be coupled to the databases 204 via one or more intermediate systems.

A plurality of users (206-210) can access the visual schedule building system 102 via a wired and/or wireless network 212.

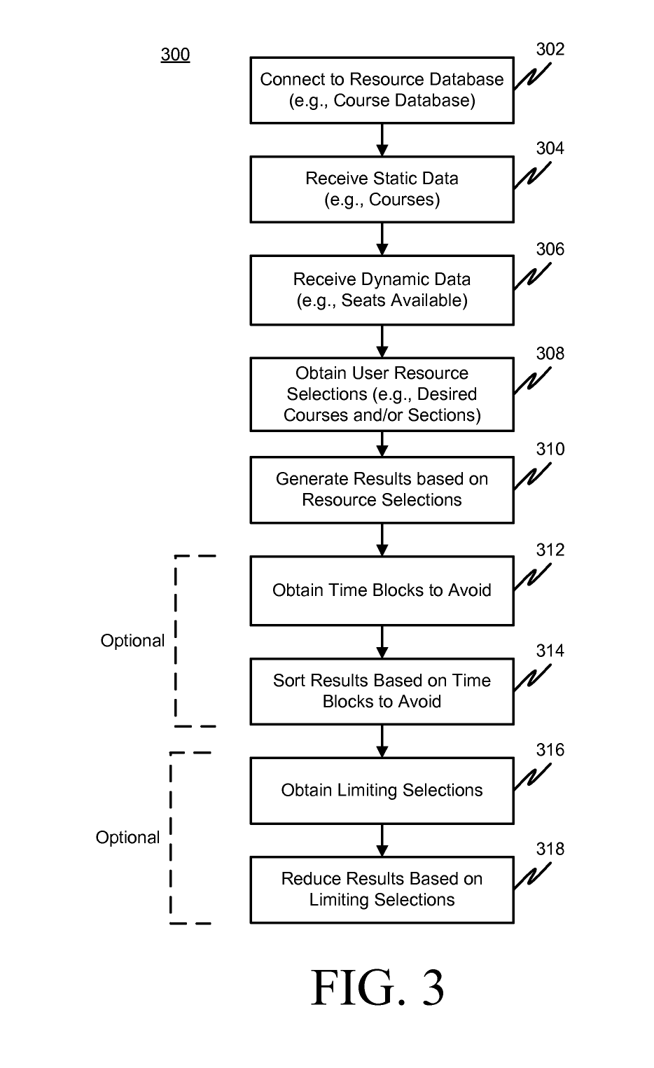

FIG. 3 is a flow chart showing an example method 300 for visual schedule building. Processing begins at 302, where a system (e.g., 102 or 202) connects to a resource database (e.g., 104/106 or 204). Processing continues to 304.

At 304, static resource data is received. Static data can include courses available or one or more active terms. Processing continues to 306.

At 306, dynamic data is received. The dynamic data can include data related to or associated with the static data. For example, a number of seats available for each course can be received. Receiving dynamic resource data can be repeated periodically (e.g., every 5 minutes) as appropriate for a contemplated application. Processing continues to 308.

At 308, one or more user resource selections are obtained. For example, course selections can be obtained. Processing continues to 310.

At 310, results are generated based on the resource selections. For example, the system can retrieve a results set including all combinations of the desired (selected) courses and/or sections. Processing continues to 312.

At 312, one or more time blocks to avoid (e.g., time constraints) are optionally obtained. The time blocks to avoid can be obtained via a user interface (e.g., 600 or 700, described below) that is adapted to permit a user to graphically select time blocks (hours and/or days) from a visual schedule interface to block. The time blocks to avoid can be selected via a “click and drag” technique on the visual schedule table view graphical user interface. Processing continues to 314.

At 314, if time blocks to avoid have been selected, the results can be resorted based on the time blocks to avoid in order to present the course schedules that most closely match the user's desired courses and time blocks to avoid. Processing continues to 316.

At 316, one or more limiting selections are optionally obtained. In a course scheduling implementation, limiting selections can include but are not limited to hiding full sections, hiding online classes and hiding honors classes. Processing continues to 318.

At 318, when limiting selections have been received, the results can be reduced (e.g., pruned) based on the limiting selections. For example, if hide full sections is selected, the results can be pruned to eliminate any schedule combination that include one or more full sections.

It will be appreciated that 302-318 can be repeated in whole or in part in order to accomplish a contemplated visual schedule building task. Further, 302-318 are not limited to being performed in the order shown and may be performed in a different order.

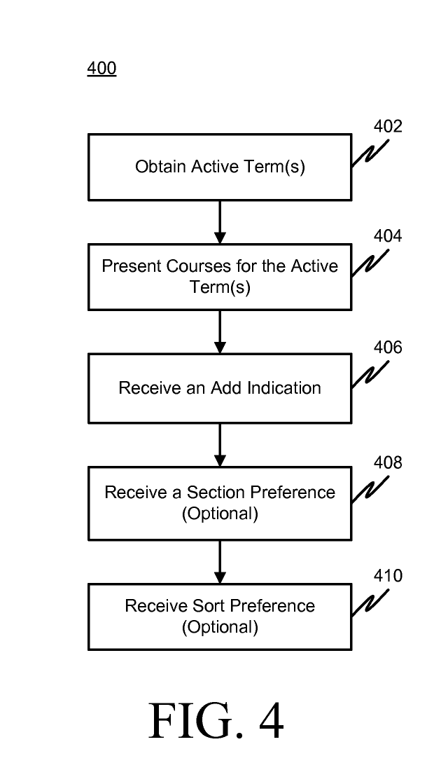

FIG. 4 is a flow chart showing an example method 400 for visual schedule building. In particular, 400 shows step 308 from FIG. 3 in greater detail. Processing begins at 402, where one or more active school terms are obtained (these can be obtained from a user or from a course and/or registration database). Processing continues to 404.

At 404, the courses available for the active term(s) are presented. For example the course can be shown on a user interface (e.g., 600 or 700) in response to a user search query or other user input. Processing continues to 406.

At 406, an indication to add one or more courses is obtained. Processing continues to 408.

At 408, a course section preference is optionally received. Processing continues to 410.

At 410, a sort preference is optionally received. The sort preference can be used as a criterion by which to rank and order the result set of course schedules. The sort preference can include but is not limited to most days off, morning classes, mid-day classes, evening classes, time off campus, healthy schedule (e.g., balanced day with time for lunch), a customized sort preference choice and/or a highest score sort preference.

The courses added, section preference and sort preference can all be used to retrieve and sort a result set of course schedules. Further, it will be appreciated that a portion of the steps of FIGS. 3 and/or 4 can be performed on a server side and a portion can be performed on a local device (e.g., desktop, laptop, tablet, wireless phone or the like). Alternatively, the steps can be performed all on the server side or all on the client device side.

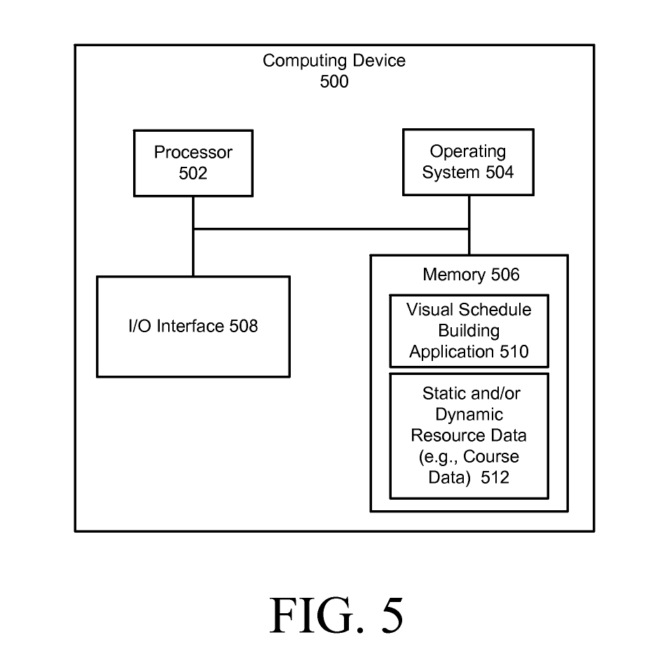

FIG. 5 is a diagram of an example computer 500 in accordance with at least one embodiment. The computer 500 includes a processor 502, operating system 504, memory 506 and I/O interface 508. The memory 506 can include a visual schedule building application 510 and a database 512 (e.g., for storing static and/or dynamic course data or data associated with other scheduled resources).

In operation, the processor 502 may execute the application 510 stored in the memory 606. The application 510 can include software instructions that, when executed by the processor, cause the processor to perform operations for network management in accordance with the present disclosure (e.g., performing one or more of steps 302-318 and/or 402-410 described above).

The application program 510 can operate in conjunction with the database 512 and the operating system 504. The computer 500 can illustrate an example server, user device or both.

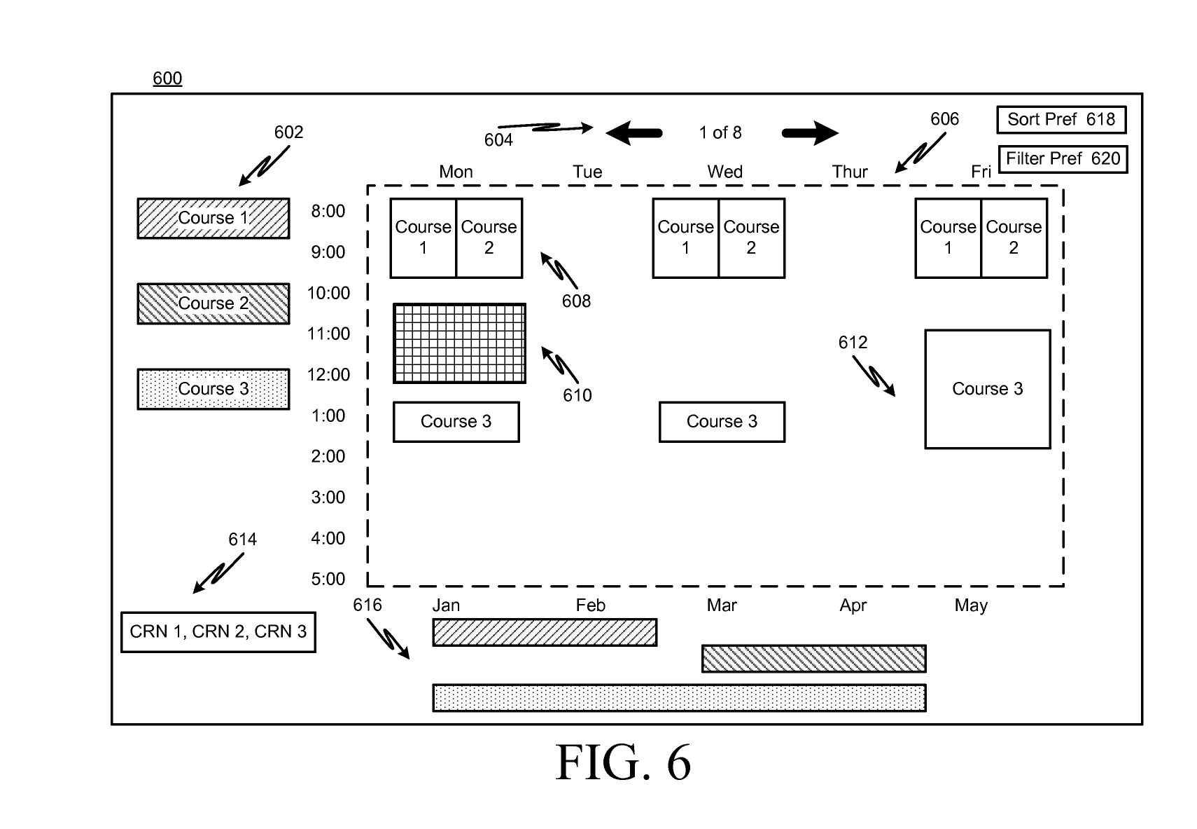

FIG. 6 is an example graphical user interface 600 for visual schedule building. The interface 600 includes a list of selected (or added) courses 602 and elements 604 for navigating among result schedules (the result schedules can be rotated though the framework of the fixed schedule table view 606).

The fixed table view 606 shows selected courses 608 (as shown course 1 and course 2 occupy the same time slot, but do not occur during the same calendar days, see 616). The fixed table view 606 also shows a time block to avoid 610 and a course with variable time length on different days 612 (e.g., a one-hour lecture with a two-hour lab component).

The interface 600 includes elements for selecting sort preference 618, filter preference 620 (or limiting preferences) and auto-populated course reference numbers for use in cut and pasting into another system (e.g., the registration system). In other words, the visual schedule builder can operate as a stand-alone program to be used for building schedules or as a program integrated with the registration system.

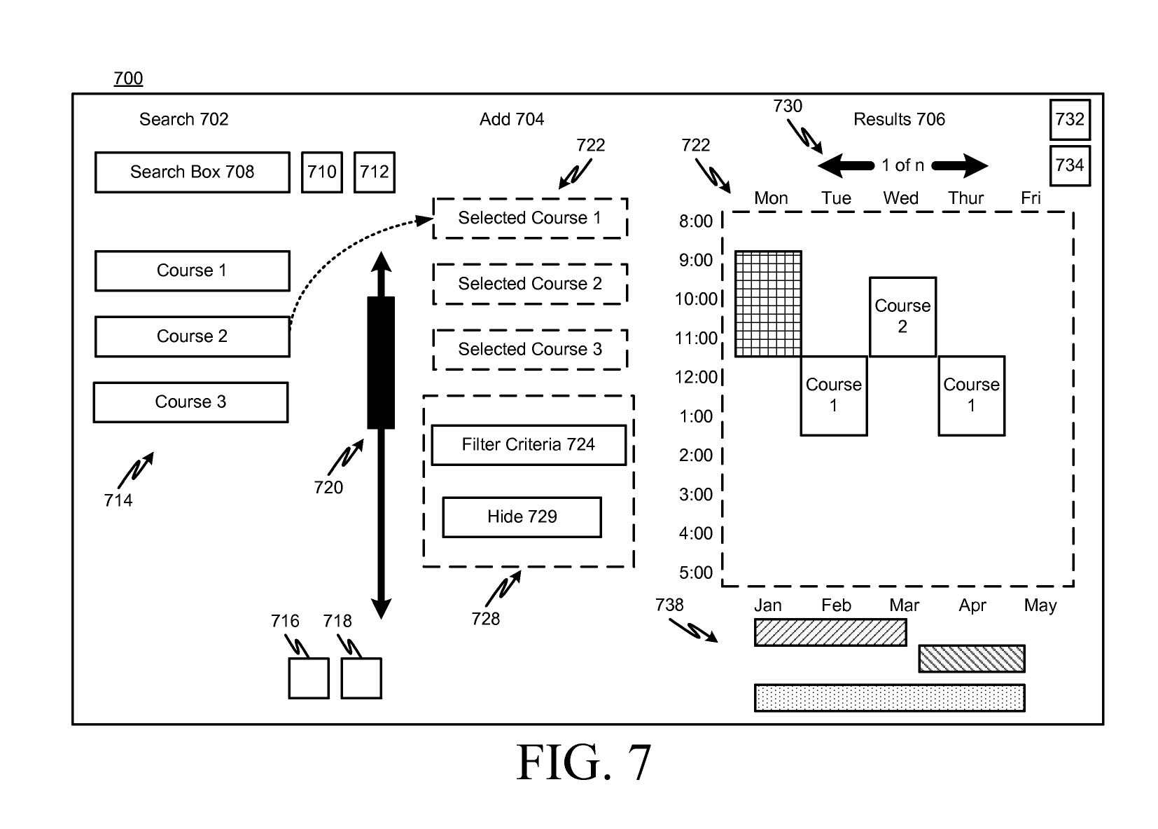

FIG. 7 is an example integrated user interface 700 for visual schedule building. The interface 700 includes a search section 702, an add section 704, and a schedule fixed table result view section 706.

The search section 702 includes a search box 708 (used for entering search terms such as course name, section name, instructor and the like), a catalog selection element 710 for search the entire course catalog or specific catalogs, and a start search element 712.

The list of result courses 714 from the search can be shown. The interface 700 also includes elements for selecting icon view 716 or list view 718. The list of search results can be scrolling using element 720.

A course in the search results 714 can be added to the course list 722 via “drag and drop” as shown by the dashed arrow. The results set can be limited (or filtered) using the filter criteria 724 and/or the hide criteria 729. The hide or filter criteria can include full courses, honors courses, online courses, waitlisted courses, campus preference (for multi-campus institutions), distance between courses based on time between courses (e.g., a student may not want to have only a few minutes to walk across campus, more time may be needed or preferred), seats available, and the like. The hide/filter section 728 can be minimized.

The course combinations shown in the fixed weekly schedule table view 722 can be changed through the result set using the controls 730. An element 730 for sharing (e.g., via email, link, calendar, social network post or the like) and exporting 734 can be provided in the interface 700.

The calendar month view 738 can include start and stop markers (not shown) that can be positioned to filter by course start/end date, respectively.

Also, in some implementations, when a mouse or pointer hovers over a section listing, a faint “ghost” of that section can be displayed on the fixed table view.

The course information can be downloaded to the visual scheduling system so that the search and sort can be done locally, which may improve response time. Also, a selected schedule can be sent to a school system (e.g., registration system) when the student has completed the visual schedule building and has selected a schedule.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for visual schedule building.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
connecting, using one or more processors, to a resource database;
receiving, at the one or more processors, static resource data from the resource database;
receiving, at the one or more processors, dynamic resource data from the resource database;
obtaining, at the one or more processors, user resource selections, wherein obtaining user resource selections includes:
obtaining one or more active school terms;
presenting, for display to the user, courses associated with the one or more active school terms; and
obtaining an add indication from the user for one or more courses;
generating, using the one or more processors, a set of results based on the user resource selections, the set of results including one or more weekly schedules; and
providing user interface controls adapted to permit the user to visually move through the set of results by displaying a weekly view of one weekly schedule from the set of results.

2. The method of claim 1, further comprising:
providing a user interface element adapted to permit the user to graphically select time blocks to avoid scheduling courses in; and
re-sorting the results set based on selected time blocks to avoid.

3. The method of claim 1, further comprising:
obtaining one or more limiting selections; and
generating a new set of results based on the limiting selections.

4. The method of claim 1, wherein obtaining the user resource selections further includes receiving one or more section preferences.

5. The method of claim 1, wherein obtaining the user resource selections further includes receiving a sort preference.

6. The method of claim 1, wherein the user interface includes a combined user interface with a first section adapted to permit a user to search courses, a second section adapted to add courses and a third section adapted visually review the results in an integrated interface.

5. A system comprising one or more processors configured to perform operations including:
connecting, using one or more processors, to a resource database;
receiving, at the one or more processors, static resource data from the resource database;
receiving, at the one or more processors, dynamic resource data from the resource database;
obtaining, at the one or more processors, user resource selections, wherein obtaining user resource selections includes:
obtaining one or more active school terms;
presenting, for display to the user, courses associated with the one or more active school terms; and
obtaining an add indication from the user for one or more courses;
generating, using the one or more processors, a set of results based on the user resource selections, the set of results including one or more weekly schedules; and
providing user interface controls adapted to permit the user to visually move through the set of results by displaying a weekly view of one weekly schedule from the set of results.

6. The system of claim 5, wherein the operations further include:
providing a user interface element adapted to permit the user to graphically select time blocks to avoid scheduling courses in; and
re-sorting the results set based on selected time blocks to avoid.

7. The system of claim 5, wherein the operations further include:
obtaining one or more limiting selections; and
generating a new set of results based on the limiting selections.

8. The system of claim 5, wherein obtaining the user resource selections further includes receiving one or more section preferences.

9. The system of claim 5, wherein obtaining the user resource selections further includes receiving a sort preference.

10. The system of claim 5, wherein the user interface includes a combined user interface with a first section adapted to permit a user to search courses, a second section adapted to add courses and a third section adapted visually review the results in an integrated interface.

9. A nontransitory computer readable medium having stored thereon software instructions that, when executed by a processor, cause the processor to perform operations including:
connecting to a resource database;
receiving static resource data from the resource database;
receiving dynamic resource data from the resource database;
obtaining user resource selections, wherein obtaining user resource selections includes:
obtaining one or more active school terms;
presenting, for display to the user, courses associated with the one or more active school terms; and
obtaining an add indication from the user for one or more courses;
generating a set of results based on the user resource selections, the set of results including one or more weekly schedules; and
providing, for display to a user, user interface controls adapted to permit the user to visually move through the set of results by displaying a weekly view of one weekly schedule from the set of results.

10. The nontransitory computer readable medium of claim 9, wherein the operations further include:
Providing, for display to the user, a user interface element adapted to permit the user to graphically select time blocks to avoid scheduling courses in; and
re-sorting the results set based on selected time blocks to avoid.

11. The nontransitory computer readable medium of claim 9, wherein the operations further include:
obtaining one or more limiting selections; and
generating a new set of results based on the limiting selections.

12. The nontransitory computer readable medium of claim 9, wherein obtaining the user resource selections further includes receiving one or more section preferences.

13. The nontransitory computer readable medium of claim 9, wherein obtaining the user resource selections further includes receiving a sort preference.

14. The nontransitory computer readable medium of claim 9, wherein the user interface includes a combined user interface with a first section adapted to permit a user to search courses, a second section adapted to add courses and a third section adapted visually review the results in an integrated interface.
